(19) United States
(12) Patent Application Publication
(10) Pub. No.: US 2009/0060372 A1
(43) Pub. Date: Mar. 5, 2009

(54) OBJECT REMOVAL FROM IMAGES

(75) Inventors: Peter Maton, Miamisburg, OH (US); Steve W. Worrell, Beavercreek, OH (US); Praveen Kakumanu, Miamisburg, OH (US)

Correspondence Address: CONNOLLY BOVE LODGE & HUTZ LLP, 1875 EYE STREET, N.W., SUITE 1100, WASHINGTON, DC, 20006, US

(73) Assignee: Riverain Medical Group, LLC, Miamisburg, OH (US)

(21) Appl. No.: 11/925,116

(22) Filed: Oct. 26, 2007

Related U.S. Application Data
(60) Provisional application No. 60/968,133, filed on Aug. 27, 2007.

(51) Int. Cl. G06K 9/40

(52) U.S. Cl. 382/264

(57) ABSTRACT

Using identification of their sizes and positions, objects may be attenuated or removed from images. This may involve the use of various filtering operations and may further include coordinate transformations prior to and/or after the filtering. The filtered objects may then be subtracted from the image.

### CROSS-REFERENCE TO RELATED APPLICATION

This application claims the priority of U.S. Provisional Patent Application No. 60/968,133, filed on Aug. 27, 2007, and incorporated herein by reference.

### FIELD OF ENDEAVOR

Various embodiments of the invention may relate, generally, to the removal of objects from images. Further specific embodiments of the invention may relate to the removal of bone portions of radiological images.

### BACKGROUND

Ribs are examples of long, approximately linear structures. A given set of ribs are the result of the same diet and growth environment and can be expected to have consistent properties along their length and from one rib to another. Nodules of interest for early lung cancer detection are generally circular local structures that may be less than some particular diameter (for example, 30 mm). Subtracting a smoothed linear structure with a wavelength larger than a specified scale selected not to be less than the particular diameter will not significantly affect an adjacent nodule nor reduce its detectability.

Detecting nodules in the presence of rib ‘noise’ will lose more nodules than the effect of rib subtraction occasionally ‘erasing’ part or all of a nodule. In a computer-aided diagnosis (CAD) device, one is likely to miss the detection of some nodules. Using known CAD methods, 25%-35% of nodules may typically be missed. By design of a system, one may make choices that affect which nodules are missed, and by what mechanism they are missed.

Computer Aided Detection (CAD) of lung nodules in chest radiographs, in which nodules may represent lung cancer, often suffers from the problem of ‘False Positives’ (FPs). False positives particularly may arise from areas in the chest image where one rib crosses another or crosses another linear feature. Similarly, the clavicle bones crossing the ribs are another common source of FPs and particularly obscure the area underneath. If the ribs and the clavicle bones were subtracted from the image the rate of FPs may be reduced, and the sensitivity may be increased.

Furthermore, due to the domination of the lung area by the ribs, the probability of a nodule being at least partially overlaid by a rib is high. The profile of the nodule may be modified by the overlaying rib and may thus be more difficult to find. Subtracting the rib may leave a far clearer view of the nodule, which the algorithm may then be able to more easily find.

### BRIEF DESCRIPTION OF THE DRAWINGS

Various embodiments of the invention will now be described in conjunction with the appended drawings, in which:

Illustrations 1-10 depict various procedures and associated results that may be incorporated into various embodiments of the invention; and

FIG. 11 shows a conceptual block diagram of a system in which various embodiments of the invention may be wholly or partially implemented.

### DETAILED DESCRIPTION OF VARIOUS EMBODIMENTS

Finding the rib (edges) in chest images is possible—we know that they are (always) there, we know how many, we know relatively where they are in relation to other anatomy and with respect to other ribs. A human can very reliably (manually) segment ribs. Conversely, finding nodules has the opposite situation. One is not certain that they are there, 99.5% of the time they are not, one does not know how many, and there is no useful model about where they might be. And a human cannot reliably detect many of them and cannot be sure that what has been detected is, in fact, a nodule (a trained radiologist may be able to locate a larger number but cannot be sure of what they are).

Therefore, performance of an automated method of nodule detection may depend on segmentation and dealing with all the objects/structure known to be in an image. Nodules are one class of anomaly that may be left behind once one has eliminated all the structures expected to be there.

Hence:
If one finds ribs, if one subtracts only those rib structures larger than the largest nodule that one expects or wishes to find, this may make nodule detection easier, and few nodules, if any, may be lost;
If one were to ‘feather’ in the edges of the subtraction, this may help to avoid edge/join artifacts that otherwise may tend to increase the FP rate; and
If one were to ‘smooth’ the structure to be subtracted before the subtraction, this may allow one to retain the ‘fine structure’ that is ‘underneath’ the subtracted object.

In line with these premises, an algorithm may be developed. The input to the algorithm may be a pair of vertex sets defining the detected edges of the bone to be subtracted. First, a smooth curve may be fitted to each vertex set. This may ensure that the bone edges are defined by a continuous function. A topological transformation may then be calculated to obtain a bone representation in a linearized, constant-width form. High-frequency variation of the bone image may then be smoothed along the bone axis. Using the region just outside the bone edges, a gradient trend across the profile of the bone may be determined and then corrected, which may then result in an approximation of the bone density in pixel value equivalent units. The gradient-corrected profiles may then be smoothed along the bone axis using the principle that the bone itself has consistent properties along its length. One aspect of this smoothing is that the degree of smoothing may be varied according to the distance from the bone edge. This variable smoothing may be used to create a more local fit close to the bone edge so that errors in bone edge detection may be better tolerated and may not create line artifacts, while the bone away from the edge may be made highly consistent by the smoothing. The smoothed representation of the bone may then be transformed back to its original curvature and width variation before being subtracted from the original image. This will now be discussed in further detail.

The accompanying drawings show a sequence of operations that may be used in various embodiments of the invention. The input may be a transformed version of the original image. This transformed version of the image may be full original resolution in size and pixel values. A further input may include coordinates of vertices defining the bone edges. In other embodiments, other representations of the bone edges may be used. This is shown in the drawings as illustrations 1 and 2.

As shown in illustration 3, one may then normalize the width and transform the bone into a linear equivalent. This may be done, for example, by a variable shear and scale transformation or by using a sampling bone profile normal to the local boundary as defined by the segmentation process; however, the invention is not limited to only these alternatives.

As shown in illustration 4, one may then apply a filter to remove high frequency features from the axial direction of the bone. The filter may be, but is not limited to, a Gaussian filter, and such a Gaussian filter may be a narrow-variance Gaussian convolution filter.

In illustration 5, the pixel values outside the bone may be separated, and a trend line across the profile for each column of the image within the bone extent may be calculated. Using the trend equation (i.e., the equation representing each trend line), one may then subtract the trend from the image, which may then result in a set of pixel values that represent the bone density.

In illustrations 6 and 7, a variable width filter may be applied along the bone axis, where the width of the filter may itself be a function of the distance from each bone edge. This variable width may have the effect of preserving the local variation in the image close to the bone edge but highly smooth along any rows away from the bone edge. This may result in a reduction in the occurrence of line artifacts along the bone edge that may arise from errors in the fitting of the detected bone edge. An example of a filter that may be used for such filter, but to which the invention is not limited, is a variable Gaussian filter. Furthermore, the width of the variable width filter may be a Gaussian function of the distance from each bone edge (but is not necessarily limited to being a Gaussian function).

In illustration 8, an attenuation filter, such as a lineal ramp or a non-linear monotonic function, may be applied at each end of the bone segment. This may have the effect of feathering the edge into the original image during subtraction so that no join may be visible.

In illustration 9, the reverse topological transformation (i.e., the inverse of the transform previously applied) may be used to restore the curvature and width of the bone. Finally, as shown in illustration 10, the bone profile may be subtracted from the original image to obtain a subtracted image. As shown in the example in illustration 10, the nodule to the left of and under the rib may be retained after the rib is subtracted.

While the illustrations have shown the use of the disclosed techniques in connection with the subtraction of ribs from chest images, such techniques may also be applied to other radiological images in which bone may interfere with observation of soft tissue phenomena. Furthermore, such techniques may also be applicable to non-radiological images in which known structures, which may be similar to bones in radiographic images, may be subtracted.

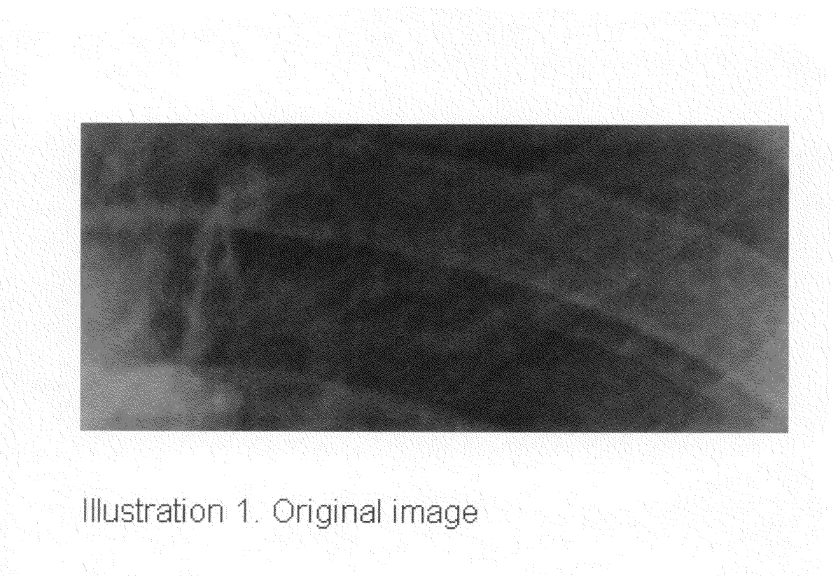

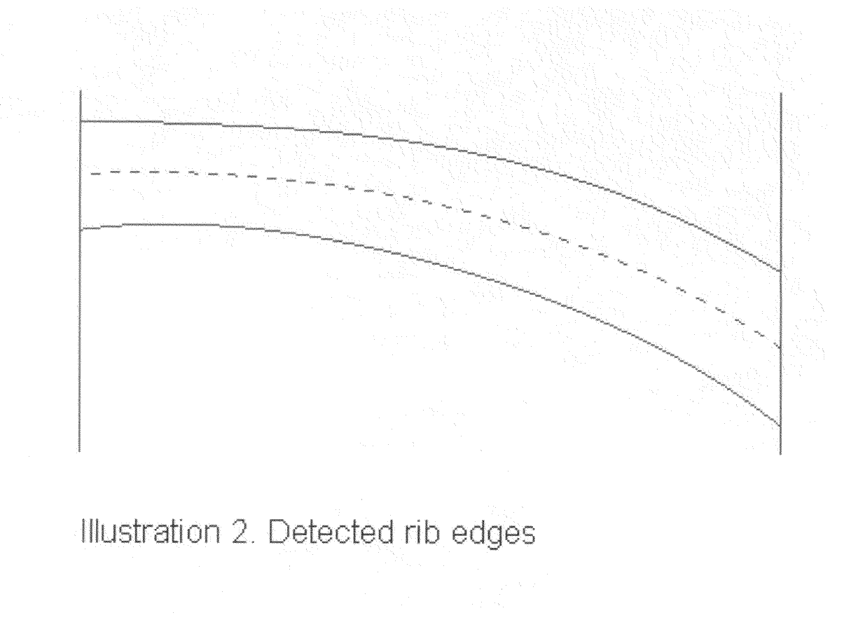

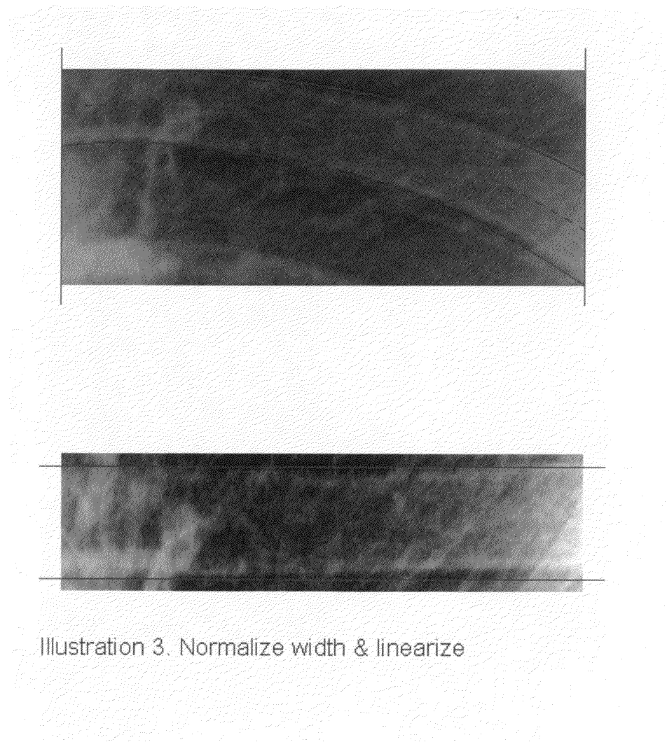

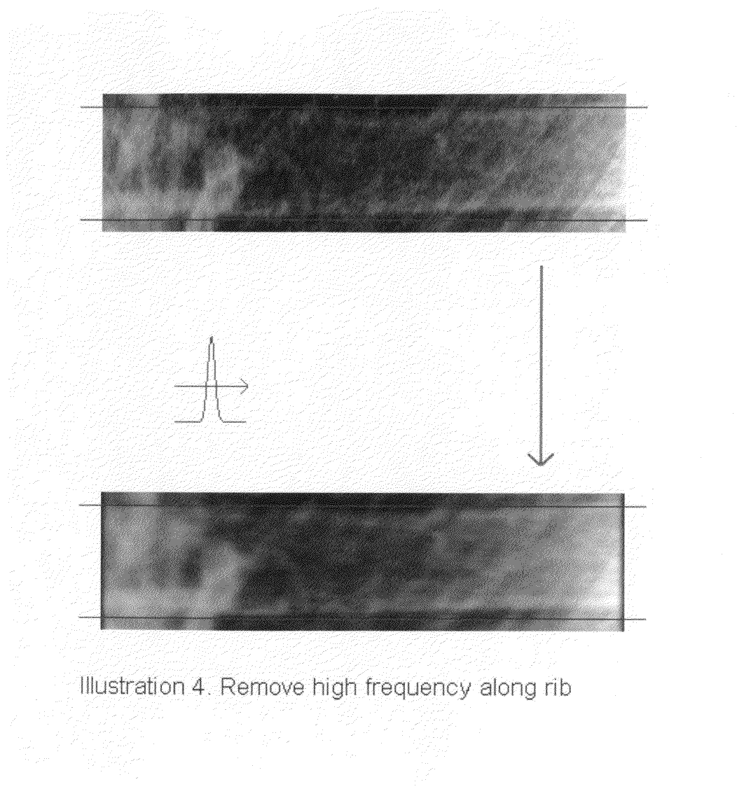

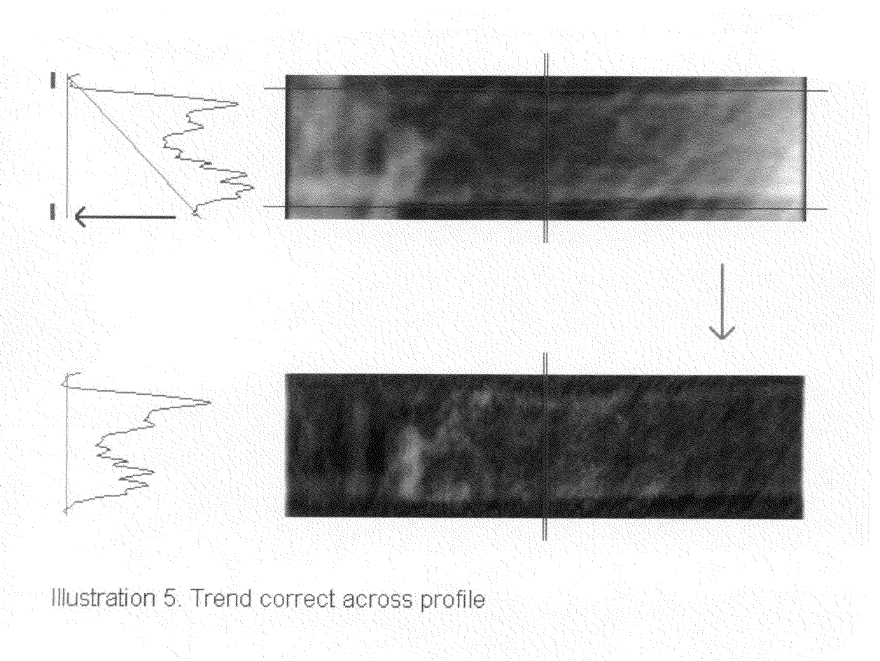

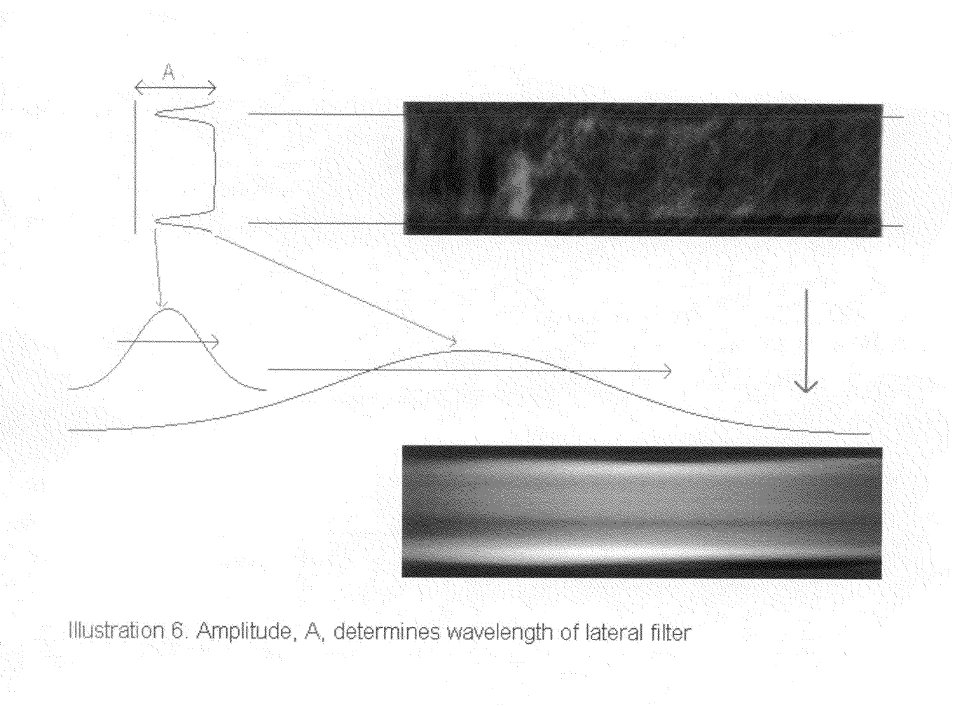

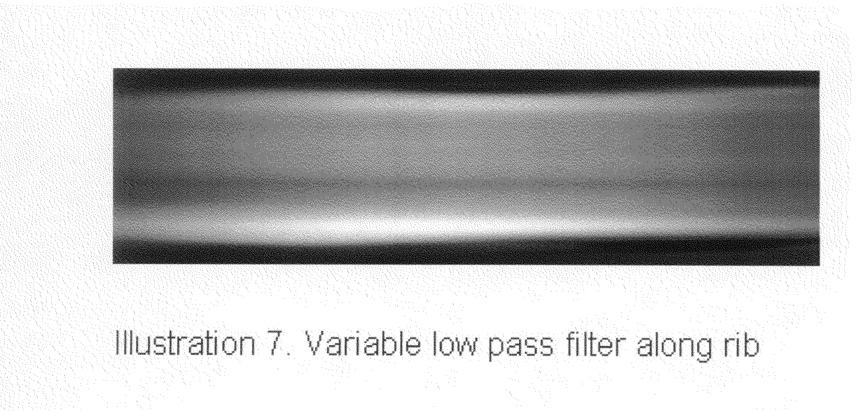

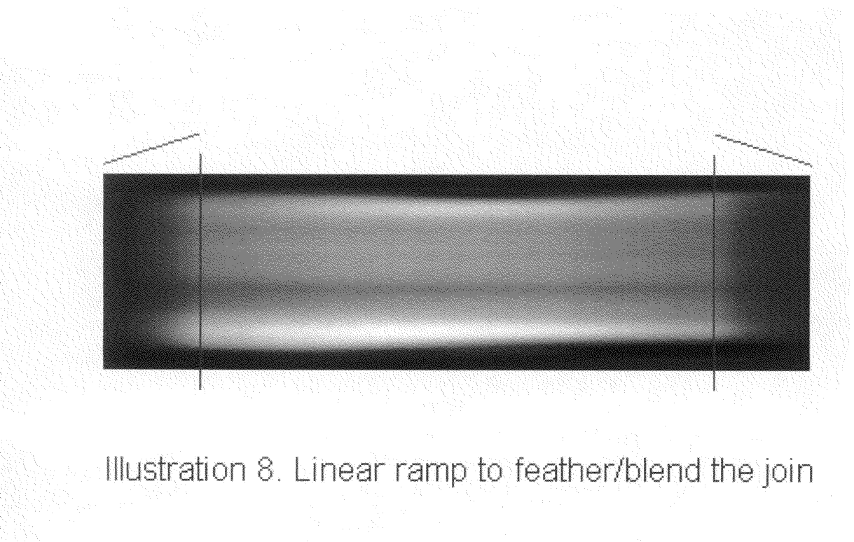

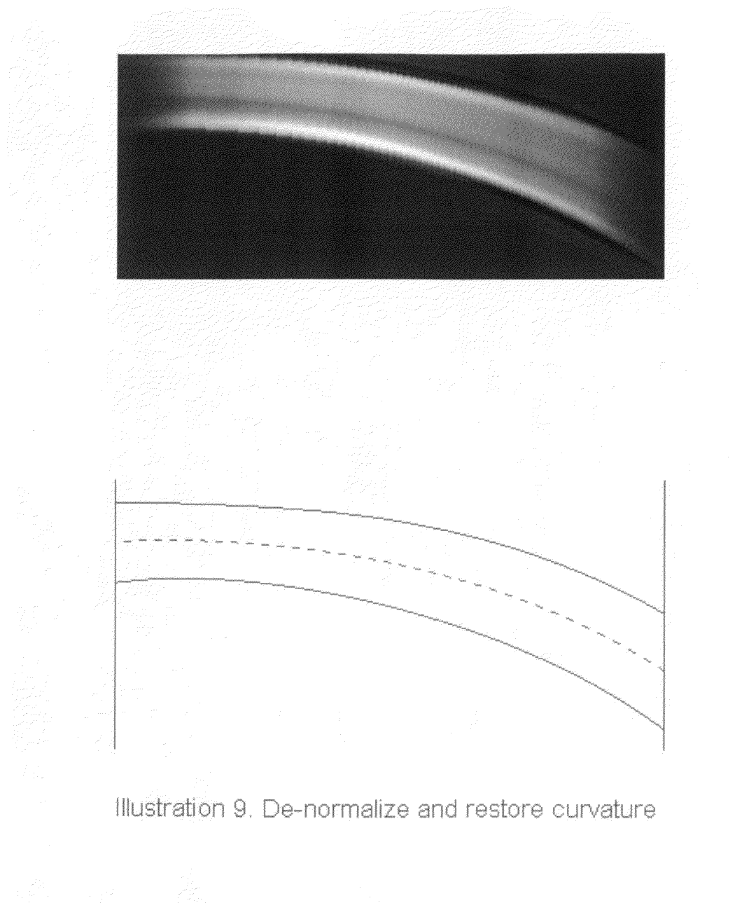

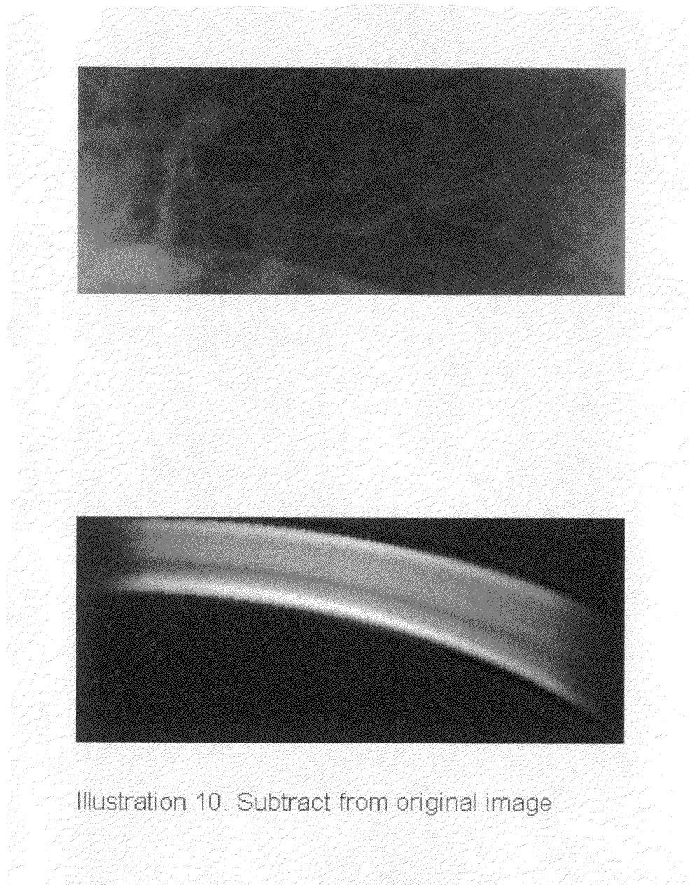

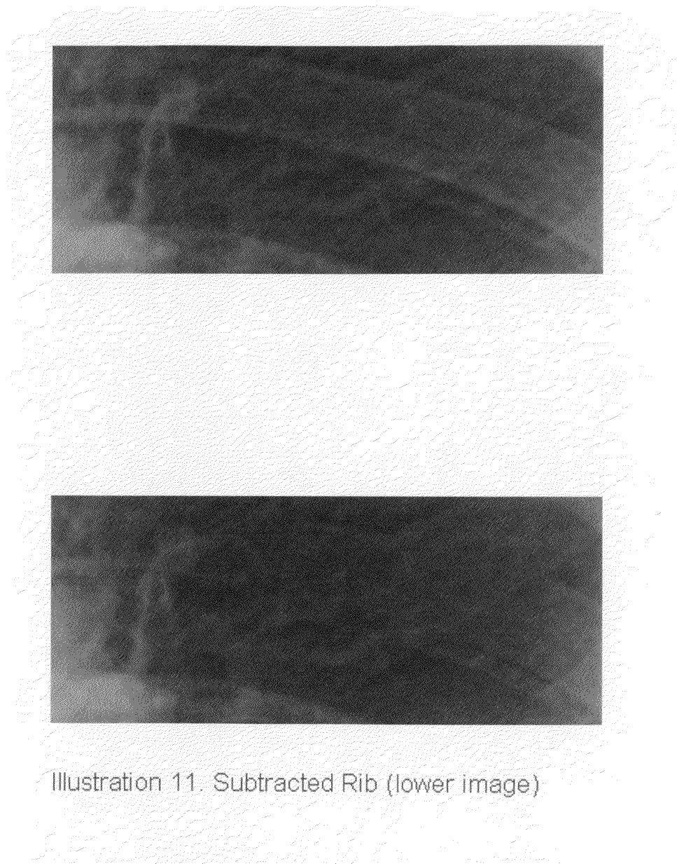

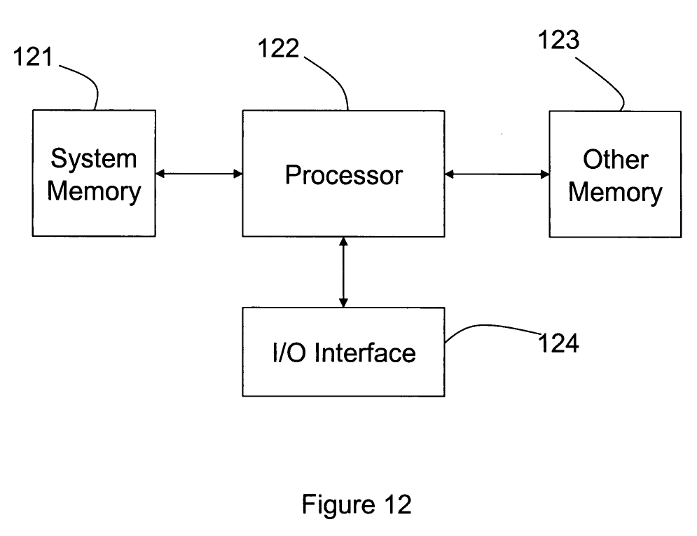

Various embodiments of the invention may comprise hardware, software, and/or firmware. FIG. 11 shows an exemplary system that may be used to implement various forms and/or portions of embodiments of the invention. Such a computing system may include one or more processors 112, which may be coupled to one or more system memories 111. Such system memory 111 may include, for example, RAM, ROM, or other such machine-readable media, and system memory 111 may be used to incorporate, for example, a basic I/O system (BIOS), operating system, instructions for execution by processor 112, etc. The system may also include further memory 113, such as additional RAM, ROM, hard disk drives, or other processor-readable media. Processor 112 may also be coupled to at least one input/output (I/O) interface 114. I/O interface 114 may include one or more user interfaces, as well as readers for various types of storage media and/or connections to one or more communication networks (e.g., communication interfaces and/or modems), from which, for example, software code may be obtained.

Various embodiments of the invention have been presented above. However, the invention is not intended to be limited to the specific embodiments presented, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

We claim:

1. A method of attenuating an object in an image, comprising:
receiving an input comprising an identification of size and position of the object;
filtering a region defined by said input to remove high-frequency features;
obtaining one or more trend lines across the region and subtracting the one or more trend lines from the image to obtain a density image of the region;
filtering the density image using a variable filter to obtain a filtered density image of the region; and
subtracting the filtered density image of the region from the image.

2. The method of claim 1, wherein said input comprises coordinates of one or more vertices that correspond to edges of the object.

3. The method of claim 1, further comprising:
applying a transformation to the region defined by the input, prior to said filtering a region, to obtain a linear equivalent region.

4. The method of claim 3, wherein the transformation comprises a transformation selected from the group consisting of: a variable shear, a scale transformation and a sampling operation normal to the local boundary.

5. The method of claim 3 further comprising:
performing an inverse transformation prior to said subtracting.

6. The method of claim 1, wherein said filtering comprises:
applying convolution filtering.

7. The method of claim 1, wherein said variable filter comprises a variable Gaussian filter.

8. The method of claim 7, wherein the variable Gaussian filter has a variance that is a function of a distance from an edge of the object.

9. The method of claim 1 further comprising:
applying an attenuation filter at at least one end of the filtered density image, prior to said subtracting.

10. The method of claim 1, further comprising:
downloading, via a communication network, software code to implement said receiving, filtering a region, obtaining, filtering the density image, and subtracting.

11. A machine-readable medium containing machine-executable instructions that, when executed, cause a machine to implement a method of attenuating an object in an image, comprising:
receiving an input comprising an identification of size and position of tile object;
filtering a region defined by said input to remove high-frequency features:
obtaining one or more trend lines across the region and subtracting the one or more trend lines from the image to obtain a density image of the region;
filtering the density image using a variable filter to obtain a filtered density image of the region; and
subtracting the filtered density image of the region from the image.

12. The medium of claim 11, wherein said input comprises coordinates of one or more vertices that correspond to edges of the object.

13. The medium of claim 11, wherein the method further comprises:
applying a transformation to the region defined by the input, prior to said filtering a region, to obtain a linear equivalent region.

14. The medium of claim 13, wherein the transformation comprises a transformation selected from the group consisting of: a variable shear, scale transformation and a sampling operation normal to the local boundary.

15. The medium of claim 13, wherein the method further comprises:
performing an inverse transformation prior to said subtracting.

16. The medium of claim 11, wherein said filtering comprises:
applying convolution filtering.

17. The medium of claim 11, wherein said variable filter comprises a variable width filter.

18. The medium of claim 17, wherein the variable width filter has a variance that is a function of a distance from an edge of the object.

19. The medium of claim 18, wherein the function is a Gaussian function.

20. The medium of claim 11, wherein said variable filter comprises a variable Gaussian filter.

21. The medium of claim 11, wherein the method further comprises:
applying an attenuation filter at at least one end of the filtered density image, prior to said subtracting.
